(19) United States
(12) Patent Application Publication
(10) Pub. No.: US 2023/0182881 A1
(43) Pub. Date: Jun. 15, 2023

(54) INTEGRATED MARINE PROPULSION SYSTEM MODELING AND CONFIGURATION

(71) Applicant: UVic Industry Partnerships Inc., Victoria (CA)

(72) Inventors: Siyang Liu, Victoria (CA); Zuomin Dong, Victoria (CA); Mostafa Rahimpour, Victoria (CA); Kevin Andersen, Courtenay (CA)

(21) Appl. No.: 17/546,961

(22) Filed: Dec. 9, 2021

(51) Int. Cl. B63H 21/20; B63H 21/21; B63B 71/10

(52) U.S. Cl. CPC B63H 21/20; B63H 21/21; B63B 71/10; B63H 2021/202; B63H 2021/216

(57) ABSTRACT

A low-order vessel propulsion power prediction method may be performed to determine factors, including power demand parameters, used in configuring a propulsion system for a marine vessel. The low-order method may receive stability data and vessel operation profile data, in addition to computational fluid dynamics simulation results to determine predicted vessel power profiles. The predicted vessel power profiles may be used to configure a powertrain system model for the marine vessel.

### FIELD

This disclosure relates to technologies for configuring energy control systems for hybrid electric marine propulsion systems.

### SUMMARY

The design and control components of a marine propulsion system benefit from accurate prediction of a corresponding marine vessel's propulsion power demands under its intended operation cycles. All-electric ships and other marine vessels with an electric or hybrid electric propulsion system, diesel/natural gas (NG) generator(s), fuel cell system, an electric energy storage system (ESS), a DC or AC power bus, and the propulsion system's power control and energy management are being developed for increased vessel performance, increased energy efficiency, and reduced emissions. The rise of hybrid electric vessel propulsion presents new challenges in designing and controlling the complex mix of mechanical and electric drives, the ESS, and their control and coordination.

One approach to the design, power control, and energy management of this type of complex mechatronics and embedded systems includes the use of a combined system model. This integrated vessel operation-behavior-propulsion system model may be used to accurately predict the vessel's behaviors under different operation conditions to support the design and control optimizations for the best performance and energy efficiency and minimum emissions and life-cycle costs. This integrated system modelling technique may be the foundation for applying the Model Based Design (MBD) methodology in developing the advanced hybrid electric propulsion systems, as used successfully by the automotive industry.

The modelling of a marine propulsion system is much more complex than an automotive (e.g., land) vehicle's powertrain system. For example, the design and control development of a marine propulsion system may take into account the vessel operation profile model, the vessel hull resistance and propulsor thrust hydrodynamic models, and the vessel's propulsion and power system models. Integrating these models onto one integrated system model and software platform (e.g., a propulsion resistance and thrust model integrated with a propulsion system and control scheme for the vessel) allows for assessing the vessel's performance, energy efficiency, emissions, and life-cycle costs with a specific propulsion system design and operation control under the vessel's given operations. However, modelling the vessel's hull resistance and propulsor thrust is a complex task. Unlike the matured vehicle dynamics model, the hull resistance and propulsor thrust of a vessel may only be accurately predicted using computation or labor-intensive methods. The disclosure provides new technologies for integrating modelling and configuration of marine vessels and associated propulsion systems using low-order model calculations.

In one example, a method of configuring a propulsion system for a marine vessel includes, with a propulsion resistance and thrust model integrated with a propulsion system and control scheme model for the marine vessel, determining propulsion resistance and thrust demand for the marine vessel; and updating a propulsion power prediction for the integrated propulsion system and control scheme model stored in computer memory for the marine vessel based on the determined propulsion resistance and thrust demand. The propulsion resistance may include hull resistance and wind resistance, and the method may further include determining hull resistance by applying computational fluid dynamics simulation data to a hull drag and vessel surging power deduced model to generate estimated hull drag data and applying vessel operation data, stability data, and the estimated hull drag data to a low-order vessel drag regression model to generate estimated vessel performance parameters, and determining upper deck wind resistance based on a cross-sectional area of an upper deck of the marine vessel, and combining the upper deck wind resistance with an estimated wind resistance output from the low-order vessel drag regression model to determine a total resistance.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 shows a block diagram of an example modeling methodology according to some examples of the disclosed technologies.

FIG. 2 is a flow chart of an example method for determining and updating a marine vessel's powertrain system according to some examples of the disclosed technologies.

FIG. 3 is a flow chart of an example method for using a low-order model to calculate parameters for use in updating a marine vessel's powertrain system according to some examples of the disclosed technologies.

FIGS. 4-6 are a flow charts of example detailed methods for operations of the method shown in FIG. 3, according to some examples of the disclosed technologies.

FIG. 7 is a block diagram of an example marine vessel, schematically showing an example propulsion system according to some examples of the disclosed technologies.

FIG. 8 depicts a generalized example of a suitable computing environment in which the described innovations may be implemented.

FIGS. 9 and 10 are example graphs showing differences between predicted and measured propeller shaft power and speed for example applications of the disclosed technologies.

### DETAILED DESCRIPTION

### Introduction

In this disclosure the words “a” and “an” are to be construed to include the singular and the plural unless otherwise stated such as by using the word only. Thus, if there are a plurality of particular elements, there is also “a” or “an” of the particular elements. In addition, the phrase “coupled to” encompasses direct connection elements as well as indirect connection of elements through one or more other elements. Also, the term blocked with reference to audio pathways simply means that audio information does not pass along the pathway, whether a physical path is interrupted or audio information is not flowing through the path. Also, pathways can include, but are not limited to channels, such as RF frequency channels or channels between Bluetooth® connected devices, but can also include data flow paths such as where data passes along a common path with the data being coded or otherwise separable with the separated data being deemed to have passed along a respective associated pathway. Audio pathways also include audio links between components. A control data pathway or an audio pathway can comprise two separate channels, one channel for transmitting data with a transmitter and one for receiving data with a receiver. Alternatively, a control data pathway or an audio pathway can comprise a single channel for both transmitting and receiving data with a transceiver.

The phrase “each element includes” does not preclude the presence of other similar elements that lack some of the components specified by the phrase “each element includes” as the other similar elements would not be within the phrase “each element includes” if it lacks some of the included items. As a specific example, the phrase each speaker unit of a system includes a speaker and a transmitter does not preclude the existence of speakers in the system without transmitters as the speakers without transmitters would not in this example be speaker units. Also, the term “and/or” is to be broadly construed to include “and”, “or” and both “and” and “or”.

As described above, the complex nature of marine vessel mechanical components and environmental considerations creates difficulties in determining and optimizing operational parameters and other configuration parameters for controlling the propulsion system of the marine vessel, especially when configuring a hybrid electric propulsion system. For example, the Model-Based Design (MBD) technology developed by the automobile and aerospace industries led to the successful development of hybrid-electric vehicles. This MBD technology is also useful for developing clean marine vessels with electrified and hybrid electric marine propulsion systems. As used herein, a marine vessel may refer to any powered watercraft, such as boats, ships, or other vessels configured to traverse water (e.g., cargo ships such as container ships, bulk carriers, tankers, etc., passenger ships such as cruise ships, ferries, etc., recreational boats or ships such as yachts, motorboats, powerboats, speedboats, pontoon boats, etc., military ships, jet skis, etc.). The marine vessel may utilize a propulsion system to control movement of the vessel through water. The propulsion system of the marine vessel may include a propulsion device, such as a propulsor (e.g., nozzle, jet, thruster, cycloid drive, magnetohydrodynamic drive, etc.), propeller (e.g., un-ducted propeller, ducted propeller, etc. coupled to a motor), and/or other mechanical device(s) that interacts with the water, imparting forces for propelling the vessel through water. The propulsion device may be powered directly or indirectly (e.g., via a propulsion driver device, such as a motor) by electrical energy provided by electrical energy producers or sources, such as engine(s), batteries or other energy storage devices, etc. One or more control systems may be used to selectively operate the energy producers and direct resulting electrical energy to devices of the propulsion system based on various factors such as operational modes, operating conditions, environmental conditions, efficiency targets, etc.

MBD relies on integrated modelling and simulation software to allow the joint design optimization of the complete propulsion system and its targeted controls. The software can comprise of two interconnected functional modules: a) propulsion power demand prediction of the vehicle/vessel at each instance of time, and b) propulsion power system and controls to meet the required power demand during the transportation mission.

Part b) can be similar for land-based vehicles and marine vessels, while part a) can be different for land-based vehicles and marine vessels. The propulsion power demand prediction for a vehicle is done by defining its driving/load cycles and the matured vehicle dynamics model. The existing propulsion power demand prediction methods for a marine vessel, on the other hand, is either too simple and inaccurate, or too computation- and labor-intensive to fit within the integrated modelling and simulation software and interface with the propulsion power system and control modelling module.

For example, part a) of the MBD process for obtaining the vessel's power demand is difficult to perform since the complex hydrodynamic model is not trivial to use. Vessel power prediction may be a complicated task for several reasons. For example, marine vessels have distinct hull geometry and propulsor, demanding different vessel hull resistance and thrust calculations, and these calculations use intensive Computation Fluid Dynamics (CFD) simulations for accurate results. Further, the ocean environment is hard to model and predict, making the wave, wind, and current-induced resistance non-trivial to predict. Additionally, vessels' loading conditions vary greatly, leading to changed displacement and drag. The weight difference between full and partial loads has an enormous impact on power demand. Furthermore, many marine vessels are not mass-produced. Thus, a power profile produced for one marine vessel may not be representative of others. Opportunities to adjust vessel propulsion system and controls may be reduced after the vessel is manufactured; accordingly, the disclosed technologies may be used help to ensure that such features are set to maximize performance, efficiency, etc. from the start of operation of the marine vessel.

Traditionally hull drag and propeller thrust models follow four different techniques: generic empirical equations, sea trial approaches, tow tank and water tank experiments, and full-scale computational fluid dynamics (CFD) simulations. Generic empirical equations may include empirical data-driven equations, documented in marine engineering textbooks, which have a relatively simple form. However, the parameters of these equations are vessel-dependent, leading to inaccurate modelling results for new vessels. Sea trial approaches can be applied to existing vessels, vessel rectification, and vessel power demand model verification. The process, however, cannot support the design and development of an entirely new vessel. Tow tank and water tank experiments may use scaled hull and propeller models, however, the approach typically utilizes costly testing facilities and extensive experiment efforts, and is subject to inaccuracy due to model scaling. Full-scale CFD simulations are used widely at present by industry in designing new vessels, and can accurately simulate the tow tank experiments. However, as noted above, this approach utilizes intensive computation in the CFD simulations, and thus is difficult or impossible to be incorporated into the integrated hybrid electric marine propulsion system.

The accurate vessel hull resistance and propulsor thrust methods of experimentation and full-scale CFD simulations, used in the marine propulsion system design at present, are labor and computation-intensive and are conducted by specialists over an extensive period of time. Their results are analyzed and interpreted for subsequent propulsion system design and control development. These isolated tasks, which are standalone processes that cannot be utilized in model-based designs, preclude the dynamic feedbacks and closed-loop adjustment of the multiple degree-of-freedom design process, forming the obstacle for designing and optimizing marine propulsion systems, such as hybrid electric marine propulsion systems.

A new method for integrating the modelling and design optimization of vessel propulsion systems is introduced in this disclosure to address the above-described issues encountered in prior approaches. In order to enable the model-based vessel propulsion system design, a vessel shaft power demand prediction method, namely, the low-order vessel propulsion power prediction model, is described herein. The disclosure introduces a method for producing an accurate and “compact” modelling tool and software to form the part a) of MBD for marine vessels to support the design and development of complex, advanced hybrid electric and electrified propulsion systems for various marine vessels. This approach may be referred to as a Low-order Vessel Propulsion Power Prediction method (LOPM). Some features of the disclosed technologies are introduced below.

The disclosure provides an introduction of a fully integrated vessel propulsion system simulation and computation model for predicting vessel performance, fuel/energy efficiency and emissions, for a given vessel design, powertrain system configuration and operation profile, forming the Integrated Marine Propulsion System Modelling Tools (IMPSMT). This integrated overall system model may combine four sub-system models, a) the vessel hull resistance model, b) the propulsor thrust model, c) the vessel powertrain system model, and d) the vessel operation profile model. For example, parts a) and b) of the overall system model may form a propulsion resistance and thrust model that is integrated with a propulsion system and control scheme model comprising parts c) and d) of the overall system model. The assessment of vessel performance, energy efficiency, emissions and life-cycle costs using the integrated model (or IMPSMT) support the assessment and design optimization of the vessel and its propulsion system, including hull and propeller design, powertrain architecture, and powertrain component sizing, as well as the development of power control and energy management strategies of the propulsion system (e.g., targeted for vessel propulsion efficiency, performance, and emissions, as well as the operation life and lifecycle costs of selected powertrain components, and/or balances between these factors).

The disclosure also provides an introduction of accurate and closely-related computation models for calculating the hull resistance and propulsor thrust of a vessel, incorporated into the IMPSMT. For example, a pair of computation models have been introduced at two different levels: dedicated, low-order hydrodynamic model (coefficients obtained from vessel stability book or from one-pass CFD vessel stability study ahead), and reduced-order hydrodynamic model (coefficient matrices obtained from full-scale CFD ahead). The high-fidelity and easy to compute hull resistance and propulsor thrust models may be used to obtain vessel propulsion power demand at different levels of complexity and comprehension for distinct design and control development targets. In addition to excellent accuracy, these models are compact and computationally efficient to support their integration into the IPSMT.

The integrated vessel propulsion system model, or IPSMT, may be implemented on one or more computation and system dynamics simulation platforms, such as MathWorks' MATLAB/Simulink. The IMPSMT may be used to carry out design and control optimization of various marine propulsion systems, including diesel/natural gas (NG) mechanical and diesel/NG electric propulsion systems, and advanced hybrid electric, pure electric, and/or hydrogen fuel cell hybrid electric propulsion systems.

### Example Modeling Systems

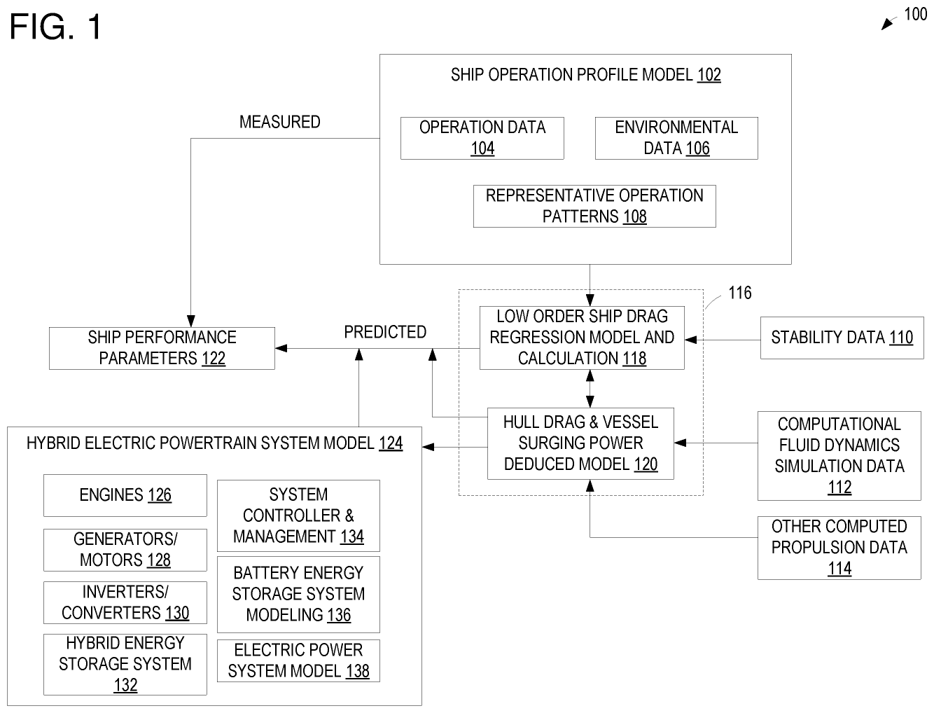

With reference to FIG. 1, an example system 100 for marine propulsion system modeling and configuration is shown, according to some examples of the present disclosure. The following example describes implementation of the systems and methods described herein in the context of a hybrid electric marine vessel for purposes of illustration, but the disclosed systems and functionality can be implemented in any of a variety of settings, including fully electric marine vessels and hybrid electric marine vessels having any suitable combination of internal combustion engine (IGE), fuel cell system, electric motors, generators, energy storage system (ESS), and related components. For example, a hybrid electric marine vessel may include an engine, such as an IGE, and a secondary fuel system, such as a fuel cell system, in combination with one or more other components to generate electrical energy usable to power propulsion devices and/or propulsion driver devices of the vessel.

A vessel operation profile model 102 includes data relating to the marine vessel, which may be used to determine vessel configurations (including control schemes for the propulsion system of the marine vessel) in accordance with the described technologies. The vessel operation profile model 102 may include operation data 104, such as positioning data (e.g., location, speed, route, heading, etc.), wind data, current data, cargo load data, noise data, power (e.g., speed/torque), etc. The operation data may be obtained by one or more dedicated sensors such as a Global Positioning Sensor (GPS), accelerometer, gyroscope, etc. and/or other devices, such as a voyage data recorder (VDR). The vessel operation profile model may also include environmental data 106, such as marine weather state load data (e.g., wind, wave, current, tide, etc.). The environmental data 106 may be measured by on-board devices of the marine vessel and/or external sources (e.g., a centralized weather station). Representative operation patterns 108 may also be included in the vessel operation profile model 102, and may include drive and load cycles for the marine vessel.

In addition to the vessel operation profile model, other data may be acquired to be used for determining parameters for the marine vessel. For example, stability data 110 may include stability book data and one-pass computational fluid dynamics (CFD) results for stability data (e.g., using a simulation computer program). CFD analysis may also be performed to determine other simulation data 112, such as propeller thrust/torque coefficients. Additional computed propulsion data 114 may include propeller thrust, off-condition/cavitation, and/or other data determined using computer programs, such as a three-dimensional time-domain panel method code for rotors used to analyze hydrodynamics, structural integrity and coupled fluid-structure interaction. Accordingly, the geometry data is accessible from either a real vessel or a vessel's CAD model, while the stability data may be obtained from the trim and stability booklet if the vessel is tested through sea trial, or estimated using CFD simulation. To perform the CFD simulation, the vessel's loading condition is used. For some examples, the full load departure condition is considered. Under the certain loading condition, the vessel's weight can be used to estimate the still water displacement using the conventional buoyancy equation F_{f}=ρ_{water}V_{displacement}g. The volume of displacement is then used for estimating the vessel draft by measuring the same amount of volume from the bottom of the vessel. Then the draft is used as a major input to vessel hydrostatic and hydrodynamic simulation for finding the vessel's center of buoyancy.

The data described above at 102-114 may be input to a low-order vessel propulsion power prediction method (LOPM) 116. In the illustrated example, The LOPM can comprise two subcomponents, a low-order vessel drag regression model and calculation method 118 and a hull drag and vessel surging power deduced model 120 (e.g., Holtrop and Mennen's model, which may include a CFD simulation surging thrust and iterative propeller speed estimation model). The modified low-order model and calculation method 116 utilize the vessel's stability data, geometry parameters, empirical equations, and one-pass CFDs to compute the vessel's overall resistance. The total vessel resistances can comprise hull viscous resistance, wave-forming resistance, and upper deck wind resistance. The wind resistance can be calculated using wind speed data, the vessel's projected cross-sectional area, and empirical equations. The hull resistance model 120 is built based on Holtrop and Mennen's hull resistance regression method as shown in Equation 1.

R_{T}=R_{F}(1+K₁)+R_{APP}+R_{W}+R_{B}+R_{TR}+R_{A} Equation 1

where, R_{T} is the total resistance, R_{F} is the friction resistance, 1+K₁ is the hull form factor, R_{APP} is the resistance of appendages force, R_{W} is the wave-making and wave-breaking resistance, R_{B} is the additional pressure resistance of a bulbous bow near the water surface, R_{TR} is the additional pressure resistance of immersed transom stern, and R_{A} is the model-vessel correlation resistance.

The regression model 118 is originally constructed based on sea trial data. To represent different vessels, a wide range of coefficients and parameters may be selected based on the vessel's geometry profile. Such a method introduces errors that can be acceptable for conventional propulsion system design. For hybrid propulsion system design, more accurate resistance prediction can be appropriate. Therefore, one-pass CFD may be used to calibrate the regression model by computing the vessel-specific coefficients including but not limited to stability data (trim, draught, and center of buoyancy, for example) and hull form factors. With the regression model capturing the hull dynamics, only one-pass CFD that can be performed on normal workstations and conventional CFD software are used. Two methods interact with each other to boost accuracy without requiring physical vessels, prototypes, or supercomputers.

The second part, Holtrop and Mennen's hull drag and vessel surging power deduced model 120, estimates the vessel's propulsive shaft power demand based on a backpropagation method using Equation 2.

$${η}_{propulsive} = \frac{effective propulsion power}{shaft power} = \frac{propulsion force * velocity}{torque * rotational speed} \qquad Equation 2$$

When estimating the power demand, the typical approach from the naval architecture fields only focuses on maximum power demand and disregards the kinematics and mission profile. On the opposite side, the motion control field explicitly studies vessels' maneuverability in waves and current under mission profile; hence, 6 degrees of freedom (DOF) are often considered. The disclosed method, in some examples, takes the midground by considering the mission profile with corresponding kinematics in 1 DOF in the surging/sailing direction. Such consideration is sufficient for propulsion system design and takes advantage of low computational intensity. With the 1 DOF consideration, the model is considered a low-order model. However, it is to be understood that other degrees of freedom can be added to the low-order model, such as varying directions of wind loading on the vessel superstructure (e.g., at an angle to the vessel's direction of travel), water currents and/or waves acting on the submerged portion of the hull (e.g., at an angle to the direction of travel), forces due to navigational inputs (e.g., rudder angle changes), forces due to shifting of loads while underway (e.g., liquid and/or particulate cargoes, containers, etc.), and/or any combination thereof. For example, resistance may be modeled for three degrees of freedom to capture resistance effects of/on maneuvering the vessel.

Similar to the first part, one-pass CFDs are performed to construct lookup tables for propeller's efficiency, torque coefficient, and thrust coefficient. Based on Equation 2, a specified or targeted propulsion power is computed using the vessel's velocity, resistance, and mass acceleration. With the propeller efficiency, the targeted shaft torque and rotational speed can be obtained. Combining with the lookup-table value (serve for calibrating rotational speed and torque iteratively), the shaft torque and rotational speed can be estimated, and thus, the shaft power may be obtained.

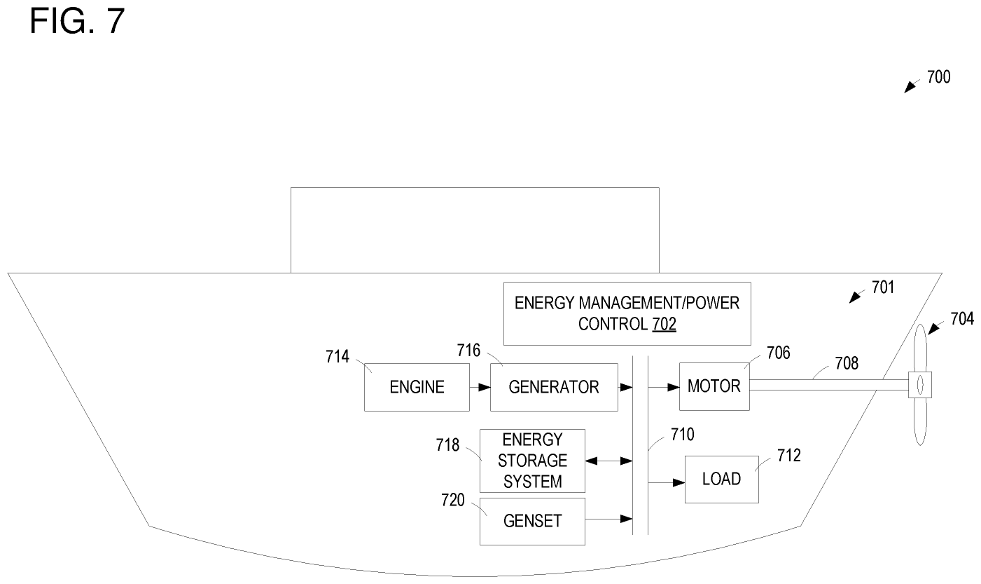

The results of the LOPM 116 may be provided alongside measured data from the vessel operation profile model 102 to vessel performance parameters 122, as well as to a hybrid electric powertrain system model 124 for the marine vessel. The vessel performance parameters 122 may be used to configure the marine vessel's operational performance (e.g., speed, acceleration, requested power, energy efficiency, emissions) targets. The powertrain system model 124 may be used to configure the operating parameters of the powertrain system of the marine vessel in order to achieve the operational performance targets. For example, the powertrain system may include engines 126 (e.g., diesel, natural gas (NG), etc.), generators/motors 128, inverters/converters 130, and hybrid energy storage system 132 (e.g., to store excess generated energy for later distribution to propulsion components such as propellers). The systems and methods described herein can select or suggest powertrain configurations, including prime mover type (e.g., internal combustion engine, gas turbine engine, electric motor, etc.), prime mover size (e.g., engine displacement) and/or power output, the number and/or position of prime movers, fuel type, the number and configuration of propellers, propulsors, or other propulsion drivers, etc., the shape, size, and/or configuration of hull or other structural elements of the vessel, target/maximum load configurations, and/or other features of the vessel to conform to selected design parameters including greenhouse gas emission constraints, fuel consumption constraints, speed requirements/targets, etc. The powertrain system model 124 may also include control components such as system controller and management unit 134, battery energy storage system modeling unit 136 and electric power system model unit 138, which may be used to control the other components of the powertrain system to achieve the operational performance targets. Additional description of example powertrain components is provided below with respect to FIG. 7.

For example, depending on the application, a control objective for the control components of the vessel (e.g., units 134-138) may vary; however, some example goals include reducing fuel usage/emissions level and increasing overall system efficiency. The control components may, in some examples, provide a two-level system: upper-level supervisory control and lower-level components control. Due to the existence of multiple energy sources in some marine vessel configurations, the power control of each element and the energy management between sources can directly influence the performance of the propulsion system, which may be decided by the upper supervisory control scheme. The lower-level may be responsible for components functionality, such as when the motor controller drives the motor based on the upper level's command. The lower level control may be used to ensure the propulsion system functions in an expected manner.

The upper-level energy management system (EMS) may be responsible for managing each vessel component's energy flows and power generation/consumption. The EMS may include rules-based controls (e.g., controls that are fuzzy rule based, such as predictive controls, adaptive controls, etc. and/or controls that are deterministic rule based, such as state machines, modified power followers, power followers, thermostat controls, etc.) and optimization-based controls (e.g., controls that use global optimization, such as linear programming, dynamic programming, stochastic dynamic programming, game theory, genetic algorithms, metamodeling, etc. and/or real-time optimization, such as equivalent fuel consumption minimization, model predictive control, decoupling control, robust control, etc.). Rule-based control may include deriving a set of rules for different stages or modes of the operation processes, which may be based on heuristic, common sense, experience/experimentation, and/or optimization results. Optimization-based control may use optimization algorithms to maximize system efficiency (or another targeted factor such as performance, emissions, etc.) and minimize energy loss.

In addition or alternatively to the configuration and/or sizes of vessel components, the systems and methods described herein can suggest models, configurations, and/or operating parameters for the control components, including power/speed curves, models for controlling the generation and distribution of electrical energy between devices of the propulsion system, etc. For example, hybrid electric technology can increase the marine propulsion system's fuel efficiency based on a sizing of system components an operation of the system. Component sizes and configurations can be selected to ensure sufficient power output and reduce waste from redundant overpowering. In order to select corresponding configurations for the propulsion system to take advantage of the selected component sizes and configurations to provide still further efficiency gains (and other targeted results, described above), the power demand profile of a vessel may be estimated using the disclosed systems and methods.

As referenced above, the vessel propulsion power profile may include three parts: vessel speed profile, vessel hull resistance profile (also known as load profile), and vessel propulsor thrust model. The vessel speed profile may depend on the mission cycle, which may be measured onboard or cross-referenced from similar vessels. Vessel resistance includes various modes. For example, exposed upper decks may suffer from wind drag. The lower submerged hull of a vessel experiences drag induced by water, involving viscous drag, current drag, and wave-induced force. Those combined water-induced drags contribute the majority of the vessel resistance, for which a detailed prediction model is used in accordance with the disclosed systems and methods for power profile prediction. The propeller thrust model measures the forces required to carry the vessel loads under a targeted speed profile. The vessel's propulsion power demand can be estimated by combining all three models, and selected component sizes can be determined to configure the propulsion system.

### Example Process Methods

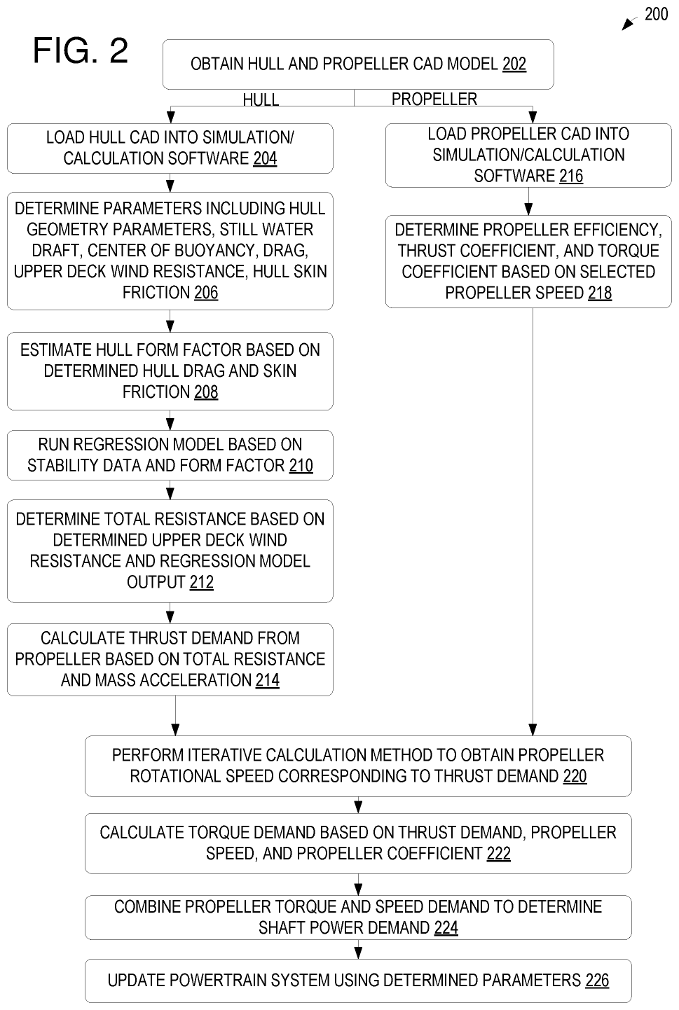

The following process flow descriptions demonstrate the interactions between the CFD and empirical equations used in the modified low-order model and calculation method described above at 116 of FIG. 1. The original Holtrop and Mennen's regression model (e.g., model 120 of FIG. 1) may be developed based on sea trial data and ITTC 57 guidelines. To use the regression model, a list of coefficients is obtained or calculated following the procedures described in more detail below with respect to FIG. 2. However, such information may not be available during the design phase; thus, CFD can be used to compute and estimate the parameters and coefficients.

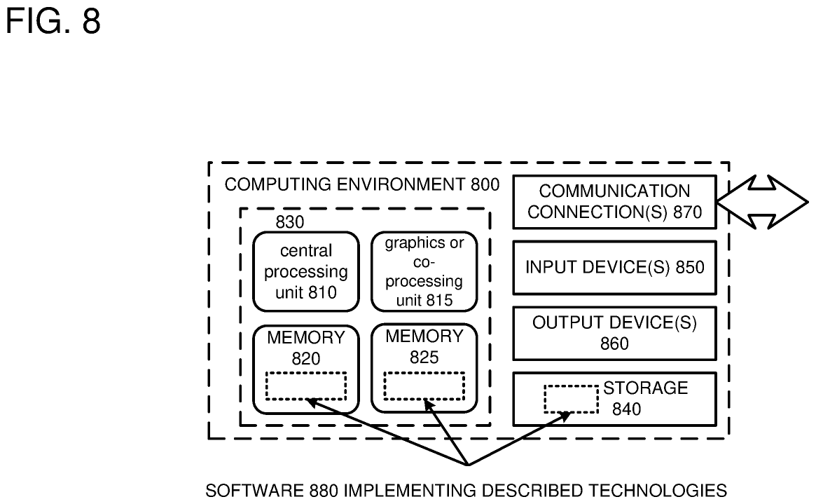

The major parameters (not limited to) to be obtained are vessel's geometry data, stability data, and hull form factor since those parameters are related to the hull viscous friction resistance, which is about 80% of the total drag. The coefficients related to wave-making resistance can be obtained through CFD for calibrating Holtrop and Mennen's regression model. The process flow of method 200 shown in FIG. 2 illustrates the interactions between the CFD and empirical equations. As described above, method 200 may be performed using one or more computing devices, an example of which is described below with respect to FIG. 8, for example to implement the system 100 of FIG. 1.

At 202, the method includes obtaining vessel parameters from hull geometry using a Computer-Aided Design (CAD) model. As shown at 204 and 216, the hull and propeller CADs may be loaded into respective simulation/calculation software. Continuing on the hull branch of method 200, the method includes determining parameters including hull geometry parameters, still water draft, center of buoyancy, drag, upper deck wind resistance, hull skin friction, etc., as indicated at 206. For example, still water draught may be calculated using buoyancy equation and direct volume measurement from the CAD model. The CAD model and draught may be used to set up a hydrostatic/hydrodynamic simulation using a computer program to determine the center of buoyancy. A hull CFD simulation may also be used to obtain drag, and hull skin friction may be determined using ITTC 57 equations. Upper deck wind resistance may be calculated by drafting an upper deck cross section based on the hull CAD to estimate cross sectional area and determining a wind resistance corresponding to such a cross sectional area.

At 208, the method includes estimating hull form factor based on determined hull drag and skin friction. For example, CFD simulations may be executed to obtain hull resistance, which is combined with viscosity friction to estimate hull form viscosity friction and further estimate hull form factor.

Turning briefly to the propeller branch of method 200, the method includes determining propeller efficiency, thrust coefficient, and torque coefficient based on a selected propeller speed, as indicated at 218. For example, the method may include obtaining propeller design parameters from the CAD model of the propeller and running a series of CFD simulations using the propeller's designed rotational speed and an array of surging speeds to obtain propeller thrust and power. The method may further include calculating and tabulating the propeller's efficiency, torque coefficient, and thrust coefficient with respect to advance ratio (e.g., ratio of freestream speed to tip speed of the propeller).

Returning to the hull branch, at 210, the method includes running a regression model based on stability data and the form factor determined at 208. At 212, the method includes determining total resistance based on the determined upper deck wind resistance and regression model output. For example, Holtrop and Mennen's regression model and parameters from CFD simulation may be used to calculate water-induced resistance, Beaufort wind scale data may be used to calculate wind-induced resistance, and the determined resistances may be combined to determine the total resistance.

At 214, the method includes calculating total thrust demand from the propeller based on combined water/wind-induced resistance and vessel's mass acceleration. At 220, the method includes performing an iterative calculation method to obtain propeller rotational speed corresponding to the thrust demand. At 222, the method includes calculating torque demand based on thrust demand (e.g., determined at 214), propeller speed (e.g., determined at 220), and propeller coefficient (e.g., determined at 218). At 224, the method includes combining the propeller torque demand and speed demand to determine shaft power demand. For example, the shaft power demand may be calculated by dividing the primary propulsion power by the propulsion efficiency. The primary propulsion power is thrust demand multiplied by vessel velocity, and the propulsion efficiency is propeller efficiency. Analytic propeller thrust and torque coefficients may be calculated using the shaft power demand.

As indicated at 220, an iterative calculation method is performed, which may be used to iteratively adjust the propeller speed, torque, thrust, and power. An example iterative adjustment method is described below. The thrust coefficient and advanced ratio table obtained from CFD is based on the designed propeller speed. When the propeller is not rotating at the designed speed, the thrust generation is lower. The program assumes the propeller rotates at the designed speed and calculates the thrust generation. Compared to the thrust demand, the program corrects the rotational speed that is suitable to thrust generation. Since such rotational speed correction changes the advanced ratio, which affects the thrust coefficient and further influences the thrust generation, the correction is conducted using an iterative method until a targeted rotational speed corresponding to the thrust demand is obtained. Example pseudo-code of the process is shown below.

| | |
|---|---|
| 1 | for the amount of the data point |
| 2 | set propeller speed n to be designed RPM and error to 10 |
| 3 | while \|error\| > tolerance |
| 4 | calculate advance ratio |
| 5 | interpret thrust coefficient Kt and calculate thrust |
| 6 | error = calculated thrust − estimated drag |
| 7 | calculate the difference of n using yielded error |
| 8 | set n = n − dn |
| 9 | end |
| 10 | record calculated n for each data point |
| 11 | end |

At 226, the method includes updating the powertrain system of the marine vessel using the determined parameters. Updating the powertrain system may include selecting or suggesting powertrain/vessel configurations (e.g., selecting type/size/configuration of powertrain/propulsion system components and/or hull/vessel shape/size/configuration) and/or control component configurations (e.g., controls for generating and distributing energy in the propulsion system), as described above. For example, determined propeller shafts targeted rotational speed, torque, and power may be output to a controller of the powertrain system (e.g., system controller and management 134 of FIG. 1).

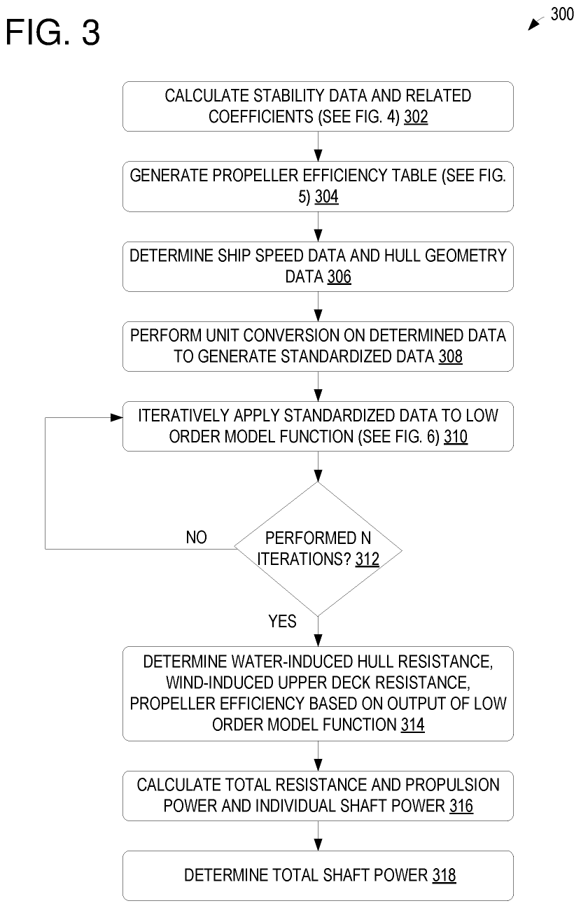

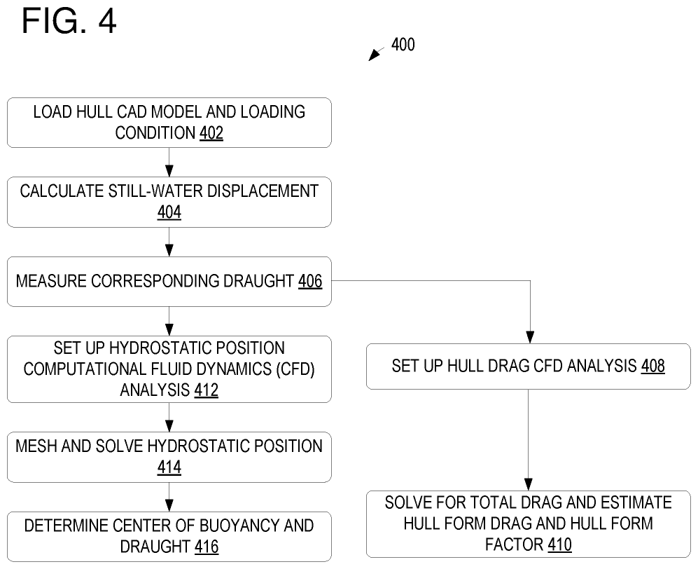

FIG. 3 shows an example subsystem method 300 for running the low-order modeling method. At 302, the method includes calculating stability data and related coefficients. Example methodologies for the calculation performed at 302 is described in more detail below with respect to FIG. 4. For example, turning briefly to FIG. 4, a method 400 for a subsystem for hull parameters pre-CFD calculation is shown. At 402, the method includes loading a hull CAD model and loading condition for the marine vessel. At 404, the method includes calculating still-water displacement and at 406, the method includes measuring corresponding draught (e.g., as described above with respect to FIG. 2). The calculated/measured data may be used to set up hull drag CFD analysis at 408 as well as hydrostatic position CFD analysis at 412. The hull drag CFD analysis may be used to solve for total drag and to estimate hull form drag and hull form factor, as indicated at 410. The hydrostatic position CFD analysis may be used to mesh and solve hydrostatic position, as indicated at 414, and to determine center of buoyancy and draught, as indicated at 416.

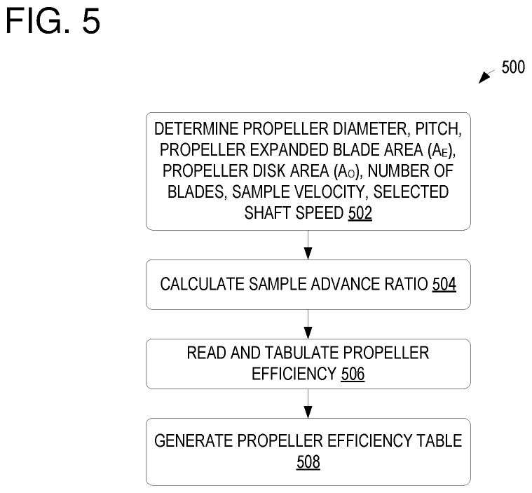

Returning to FIG. 3, at 304, the method includes generating a propeller efficiency table. Example methodologies for the generation at 304 is described in more detail below with respect to FIG. 5. For example, turning briefly to FIG. 5, a method 500 for a subsystem for propeller efficiency and coefficients pre-CFD calculation is shown. At 502, the method includes determining parameters including propeller diameter, pitch, propeller expanded blade area (A_{E}), propeller disk area (A_{O}), number of propeller blades, sample velocity, and selected shaft speed. At 504, the method includes calculating, based on the determined parameters of 502, a sample advance ratio. At 506, the method includes reading and tabulating propeller efficiency data, which is used to generate a propeller efficiency table, as indicated at 508.

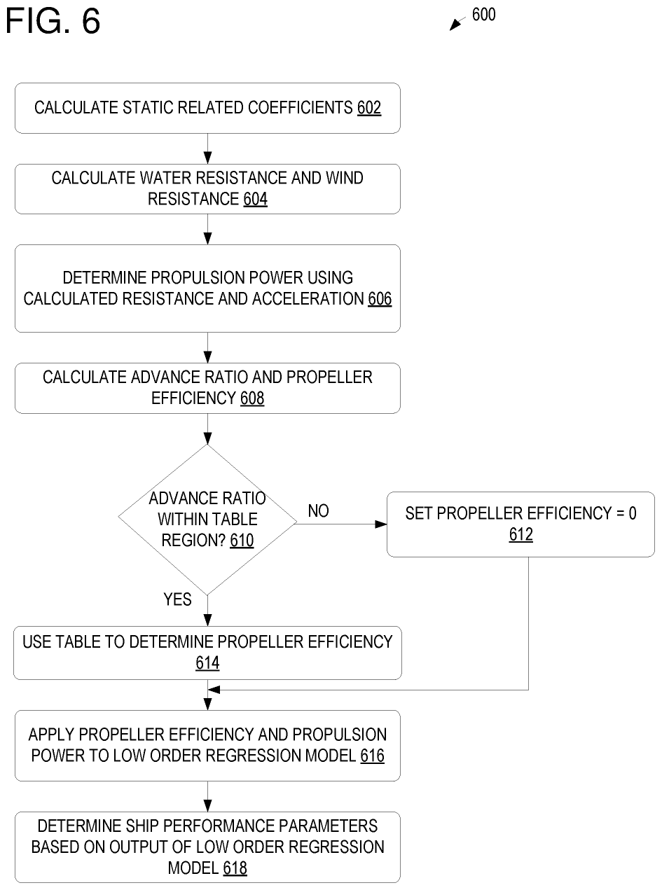

Returning to FIG. 3, at 306, the method includes determining vessel speed data and hull geometry data. The determined data is unit converted to generate standardized data, as indicated at 308. At 310, the method includes iteratively applying the standardized data to a low-order model function, such as the LOPM 116 of FIG. 1. Additional details of the operation of the LOPM is described below with respect to FIG. 6.

For example, turning briefly to FIG. 6, a method 600 for a subsystem for applying pre-computed parameters to a regression model is shown. At 602, the method includes calculating static related coefficients. At 604, the method includes calculating water resistance and wind resistance (e.g., as described above with respect to FIG. 2). At 606, the calculated resistance and acceleration data is used to determine propulsion power, which is used to calculate advance ratio and propeller efficiency, as indicated at 608.

At 610, the method includes determining if the advance ratio is within a table region. If the advance ratio is not within the table region (e.g., is not included in the table generated using method 500 of FIG. 5; “NO” at 610), the method includes setting the propeller efficiency to zero, as indicated at 612. If the advance ratio is within the table region (e.g., is included in the table generated using method 500 of FIG. 5; “YES” at 610), the method includes using the table to determine the propeller efficiency, as indicated at 614. At 616, the method includes applying the propeller efficiency (e.g., determined at 612 or 614, depending on the advance ratio) and propulsion power (e.g., calculated at 608) to a low-order regression model (e.g., model 118 of FIG. 1). At 618, the method includes determining vessel performance parameters based on an output of the low-order regression model.

Returning to FIG. 3, at 312, the method includes determining if a targeted number of iterations of the LOPM have been performed. For example, the LOPM may be repeated for a targeted number of velocity data points. If the targeted number of iterations has not been performed (e.g., “NO” at 312), the method returns to 310 to perform the LOPM. Once the targeted number of iterations has been performed (e.g., “YES” at 312), the method includes determining parameters including water-induced hull resistance, wind-induced upper deck resistance, and propeller efficiency based on the output of the LOPM performed at 310.

At 316, the method includes calculating total resistance and propulsion power, and individual shaft power. At 318, the calculated power is used to determine total shaft power. These calculated/determined values may be used by the powertrain system model (e.g., model 124 of FIG. 1) of the marine vessel to configure operations to achieve targeted performance parameters.

### Additional Example Calculation Methods

Resistance Calculations

As described above, vessel resistance can be used to estimate a propulsion power demand, and may be represented as a combination of different sources of resistance (e.g., hull resistance, which can be based on skin friction and wave/current-making pressure force resistance, and upper deck resistance, which can be based on air drag and wind-making resistance). As described above, Holtrop and Mennen's regression method may be used to estimate water-induced resistance. For example, hull skin friction can be calculated as:

R_{f}=0.5ρV²SC_{f} (Eq. 3.1)

where ρ is the fluid density, V is vessel speed, S is surface area, and C_{f} is the coefficient of frictional resistance established by ITTC 57 (International Towing Tank Conference) based on Reynolds number Rₙ:

$${C}_{f} = \frac{0.075}{{[ ( {log}_{10} {R}_{n} ) - 2 ]}^{2}} \qquad ( Eq . 3.2 )$$

Considering the irregular shape a vessel's hull may have, an additional form factor may be introduced to capture the extra surface area from the hull geometry. The factor k₁ can be calculated as:

$${k}_{1} = {c}_{13} * [ 0.93 + {{c}_{12} ( \frac{B}{{L}_{R}} )}^{0.92497} * {( 0.95 - {C}_{P} )}^{- 0.521448} * {( 1 - {C}_{P} + 0.0225 * lcb )}^{0.6906} \qquad ( Eq . 3.3 )$$

where lcb is the location of the longitudinal center of buoyancy measured from the ship center point, C_{P} is the prismatic coefficient, which is the ratio of block coefficient C_{b}, and the midship section coefficient Cₘ.

$${C}_{P} = \frac{{C}_{b}}{{C}_{m}} = \frac{{V}_{d} / ( L * B * T )}{{A}_{mid} / ( B * T )} , \qquad ( Eq . 3.4 )$$

where L_{R} is the parameter that reflects the length of run:

$$\frac{{L}_{R}}{L} = 1 - {C}_{P} + \frac{0.06 {C}_{P} lcb}{4 {C}_{P} - 1} , \qquad ( Eq . 3.5 )$$

V_{d} is the vessel molded displacement volume, L is the length of the ship at the waterline, B is moulded breadth, and T is the average moulded draft.

The appendages friction is similar to equation (3.1) with S representing appendages surface area and corresponding k₂ coefficient. Appendages may involve rudder, shaft brackets, skeg, bossings, shafts, dome, bilge keel, and/or stabilizer fins.

For ships with bow thrusters, the bow thruster tunnel may also contribute to additional resistance as an appendage. The resistance can be calculated as:

R_{bow}=ρV²πd²C_{BTO} (Eq. 3.6)

where d is the tunnel diameter and C_{BTO} is a coefficient ranging from 0.003 to 0.012.

The pressure making resistance is a more complex subcomponent of the overall ship resistance. The hull pressure resistance includes wave-making/breaking resistance R_{W}, the pressure resistance of bulbous bow R_{B}, and pressure resistance of immersed transom stern R_{TR}. The sum of these resistances is described in Froude's hypothesis and known as residuary resistance. The previously mentioned frictional resistance is a function of Reynolds number, whereas the residuary resistance only depends on corresponding speed, which is known as Froude number F_{R}. Referred to as residuary resistance (ITTC 57/87) or wave resistance (ITTC 2017), the resistance is obtained by wave resistance coefficient:

C_{W}=C_{TM}−(1+k)C_{FM} (Eq. 3.7)

where the k and C_{FM} is the aforementioned hull form factor and frictional force coefficient and C_{TM} is the total resistance coefficient. Such a method may use the towing tank method; however, when the scaled test cannot be performed, the described Holtrop and Mennen method can provide a direct empirical regression method:

$${R}_{W} = {c}_{1} {c}_{2} {c}_{5} ▽ ρ g exp [ {m}_{1} {F}_{n}^{d} + {m}_{4} cos ( λ {F}_{n}^{- 2} ) ] \qquad ( Eq . 3.8 )$$

$${R}_{B} = \frac{0.11 exp ( - 3 {P}_{B}^{- 2} ) {F}_{ni}^{3} {A}_{BT}^{1.5} ρ wg}{1 + {F}_{ni}^{2}} \qquad ( Eq . 3.9 )$$

$${R}_{TR} = 0.5 ρ {wV}^{2} {A}_{IT} {c}_{6} where \qquad ( Eq . 3.1 )$$

$$λ = \{ \begin{matrix}1.446 {C}_{P} - 0.03 L / B & if L / B < 12 \\ 1.446 {C}_{P} - 0.36 & if L / B > 12\end{matrix} \} \qquad ( Eq . 3.11 )$$

$${P}_{B} = \frac{0.56 \sqrt{{A}_{BT}}}{{T}_{F} - 1.5 {h}_{B}} \qquad ( Eq . 3.12 )$$

$${F}_{ni} = \frac{V}{\sqrt{g ( {T}_{F} - {h}_{B} - 0.25 \sqrt{{A}_{BT}} ) + 0.15 {V}^{2}}} \qquad ( Eq . 3.13 )$$

where Fₙ is the Froude number, A_{BT} is the area of transverse bulbous, ∇ is vessel displacement, and A_{IT} is the area of immersed transverse area of transom.

To describe the effect of vessel hull roughness and resistance in still air, the model-vessel resistance can be calculated as:

R_{A}=0.5ρV²SC_{A} (Eq.3.14)

where the correction coefficient is

$${C}_{A} = 0.006 {( L + 100 )}^{- 0.16} - 0.00205 + 0.003 \sqrt{\frac{L}{7.5}} {C}_{B}^{4} {c}_{2} ( 0.04 - {c}_{4} ) \qquad ( Eq . 3.15 )$$

The wind resistance may be calculated based on the model established by Journee and Massie. The wind can have two effects on the vessel during sailing. The direct impact is the wind resistance induced by the pressure acting on the projected area. An alternative effect is the wind-induced wave causing hull resistance.

The wind resistance is relevant to wind speed. However, when detailed wind data is unavailable or not yet determined, a simplification using the Beaufort wind scale can be used to estimate the wind speed. The Beaufort wind force scale calculates the wind speeds based on the Beaufort scale, and an empirical equation written as:

ν_{wind}=0.83B^{1.5}(m/s) (Eq.3.16)

where B is the Beaufort scale number. As this calculates the wind speed at 10 meters above the sea level, the result of Eq. 3.16 may be converted to vessel level using the equation:

$$\frac{{v}_{z}}{{v}_{10 m}} = {( \frac{z}{10} )}^{0.11} , \qquad ( Eq . 3.17 )$$

where the z value is the height of the vertical vessel center of gravity above the waterline.

The transverse and longitudinal wind resistance can be calculated as:

X_{wind}=0.5ρₐᵢᵣV_{rw}²C_{Xwind}A_{T} (Eq.3.18)

Y_{wind}=0.5ρₐᵢᵣV_{rw}²C_{Ywind}A_{L} (Eq.3.19)

where V_{rW}, is the relative wind speed, C_{X,Ywind} is the wind load coefficient, which is a function of wind angle α, A_{T,L} is the transverse and longitudinal projected wind area.

The relative wind speed may be calculated as:

V_{rw}=\sqrt{Vₛ²+V_{tw}²+2VₛV_{tw}} (Eq.3.20),

where V_{tw} is the true wind speed and V_{S} is the vessel's sailing speed. The relative wind angle can be shown as:

$${α}_{rw} = arctan ( \frac{{V}_{tw} sin {α}_{tw}}{{V}_{s} + {V}_{tw} cos {α}_{tw}} ) \qquad ( Eq . 3.21 )$$

with α_{tw} representing the true wind angle.

The formerly described C_{X,Ywind} is the function of the wind angle, which is calculated as:

$$\begin{matrix}{C}_{Xwind} = {A}_{0} + {A}_{1} \frac{2 {A}_{L}}{{L}_{o α}^{2}} + {A}_{2} \frac{2 {A}_{T}}{{B}^{2}} + {A}_{3} \frac{{L}_{o α}}{B} + {A}_{4} \frac{S}{{L}_{o α}} + {A}_{5} \frac{C}{{L}_{o α}} + {A}_{6} M & ( Eq . 3.22 ) \\ {C}_{Ywind} = {B}_{0} + {B}_{1} \frac{2 {A}_{L}}{{L}_{o α}^{2}} + {B}_{2} \frac{2 {A}_{T}}{{B}^{2}} + {B}_{3} \frac{{L}_{o α}}{B} + {B}_{4} \frac{S}{{L}_{o α}} + {B}_{5} \frac{C}{{L}_{o α}} + {B}_{6} \frac{{A}_{s}}{{A}_{L}} & ( Eq . 3.23 )\end{matrix}$$

where A_{L} is the lateral projected area, B is the beam at the waterline, Lₒₐ is the overall ship length, and Aₛ is the lateral projected area of the superstructure.

Propeller Efficiency Model

After obtaining the hull resistance (e.g., as described above), the propeller thrust model may be carried out to estimate the vessel's shaft power demand. Considering the fundamental physics, the product of the vessel's speed and thrust force is the propulsion power. Additional forces for achieving specific mass acceleration may be considered as well. However, when propulsion power is delivered to the final drive, the power is partially lost due to the propeller efficiency. Hence, to capture the real shaft power, the propeller efficiency may be a determining factor.

For the empirical equation, the propeller efficiency can be calculated based on the propeller thrust coefficient Kₜ, torque coefficient K_{q}, and advance ratio J as

$${η}_{0} = \frac{J}{2 π} \frac{{K}_{t}}{{K}_{q}} \qquad ( Eq . 3.24 )$$

where Kₜ and K_{q} can be calculated based on the propeller geometry and rotation speed. Both coefficients are a function of advance ratio J, pitch diameter ratio P/D, the blade area ratio A_{E}/Aₒ, Reynolds number Rₑ, the number of propeller blades Z, and the ratio of the maximum propeller blade thickness to the length of the cord at the characteristic radius 0.7R. The advance ratio can be calculated as

$$J = \frac{{V}_{A}}{nD} \qquad ( Eq . 3.25 )$$

where V_{A} is the speed of advance, n is the shaft speed in rev/sec, and D is the propeller diameter. Efficiency diagrams may be used to look up propeller efficiency, torque coefficient, and thrust coefficient based on advance ratio and pitch to diameter ratio.

Propeller Thrust Calculation

Similarly to the propeller efficiency, propeller thrust may be measured in the power prediction model since the thrust is a direct counter of the vessel resistance representing the shaft output. The aforementioned propeller efficiency shown by the equation (3.25) may be calculated based on the thrust coefficient K_{T} and torque coefficient K_{q}, which are also determining factors for the propeller thrust calculation. Equation (3.26) and (3.27) demonstrate the relation between the propeller's thrust generation and the K_{T} value as well as the torque and the K_{q}:

$$\begin{matrix}{K}_{T} = \frac{T}{ρ {n}^{2} {D}^{4}} & ( Eq . 3.26 ) \\ {K}_{q} = \frac{Q}{ρ {n}^{2} {D}^{5}} & ( Eq . 3.27 )\end{matrix}$$

The K_{T} value can also be obtained from the efficiency diagram as described above. Propeller thrust can be obtained through CFD simulation as well in some examples.

### Example Applications

In an example implementation, the low-order vessel propulsion power prediction method (LOPM) is developed using the vessel data of the BC Ferries (BCFS)'s vehicle and passenger ferry Tachek. In addition to the hull geometry and propeller design, the collected vessel's operational data includes shaft power demand, wind data, and wave conditions. The CAD models are constructed based on the drawings provided by BCFS. While creating the LOPM, the stability data is computed following the methodology described herein (e.g., described in the hull branch of FIG. 2) and validated using the stability booklet provided by BCFS. The propeller lookup table is also constructed using procedures described herein (e.g., described in the propeller branch of FIG. 2). Additional parameters and coefficients such as hull form factor are estimated using CFD simulation. The Holtrop and Mennen's regression model is constructed as described above (e.g., at 210 of FIG. 2), combining the stability data, vessel geometry, and estimated empirical equation coefficients and parameters. Combining the hull resistance, wind resistance, and mass acceleration, the total vessel thrust demand were obtained as described above (e.g., at 212-214 of FIG. 2). Finally, the shaft power demand is estimated using an iterative approach as described above at 220-224 of FIG. 2. The computed shaft rotational speed and power demand are compared and validated with the onboard-measured data.

Once the LOPM and procedure are developed and validated on the Tachek ferry, they are then applied to another BCFS ferry ship, Skeena Queen (SKQ) in another example implementation of the disclosed technologies. The same procedures are used to predict SKQ's shaft power demand, and the yielded power is compared to onboard collected data. The method may be applied to multiple types of marine vessels, as the Tachek is a fix-direction propeller ship, while the testing ship, SKQ, has azimuth drive systems. The validation and testing results indicate that the disclosed method can estimate power demands for both propulsion systems.

After validating and testing, the new modelling method may be used in a vessel propulsion system design, control development, and lifecycle optimization process as an embedded subsystem. The submodel intakes the vessel velocity profile and computes shaft power demand based on different loading conditions. The yielded power demand results serve as the baseline for propulsion system design. Since the model is embedded into the propulsion system multiphysics model in some examples, it enables the fully integrated system design and optimization. The new modelling method may be implemented and programmed in MathWorks' MATLAB/Simulink environment, however, it is to be understood that other computing environments may be used to perform the described operations without departing from the scope of this disclosure. The numerical simulation results are compared to acquired operation data of the two ferries with satisfactory consistency to validate the method.

As described above, the disclosed technologies may be applied to different types of marine vessels. For illustrative purposes, FIG. 7 schematically shows an example marine vessel 700 including a propulsion system 701, which may be configured in accordance with the modeling methodology and related technologies described herein. It is to be understood that the example propulsion system 701 provides an illustrative representation of components that may be included in suitable marine vessels that are configured in accordance with the disclosed technologies, and additional, fewer, and/or alternative combinations of components may be included in other example marine vessels that are configured in accordance with the disclosed technologies without departing from the scope of the present disclosure.

The propulsion system 701 includes an energy management/power control unit 702, which may be configured to control the operation of the illustrated components of system 701. In some examples, the energy management/power control unit 702 may include one or more of the models/controllers 134-138 of FIG. 1. For example, the propulsion system 701 may include one or more propellers 704 configured to rotate to move the vessel through water. The propeller 704 may be connected to one or more respective motors 706 via one or more respective shafts 708, where the motor 706 is configured to convert electrical energy to mechanical energy to rotate the shaft 708, which in turn rotates the propeller 704. The electrical energy may be provided to the motor(s) 706 via one or more sources connected to a power bus 710. The bus 710 may also provide electrical energy to other electrical components of the vessel, represented collectively as load 712.

Example sources providing electrical energy to bus 710 may include one or more engines 714, such as diesel engines, natural gas (NG) engines, etc., which power one or more respective generators 716, configured to output electrical energy to the bus. An additional source of electric energy includes an energy storage system 718, which may include batteries or other devices configured to store energy received from the bus (e.g., via other devices, such as excess energy from generator 716 or genset 720 not used for motor 706 and/or load 712) for later distribution to the bus (e.g., to motor 706/load 712). In some examples, a secondary fuel system, such as a fuel cell system, may be used to provide electrical energy to the bus 710 as an alternative and/or addition to the one or more engines 714.

Accordingly, the energy management/power control 702 may be configured to control the operation of the energy sources to control the distribution of electrical energy to the motor 706 and load 712, thereby controlling operation of the propeller 704. The parameters used to determine distribution operations for different conditions experienced by the vessel 700 may be set using the technologies described herein.

As described above, the disclosed LOPM has been applied and tested using two medium-sized passenger and vehicle ferries operating in British Columbia, Canada: the MV Tachek with 807 ton of maximum displacement and the MV Skeena Queen with 2942 ton of maximum displacement. The ferries' hull and propeller design data and operation profiles have been used to predict their respective required propulsion power using the LOPM.

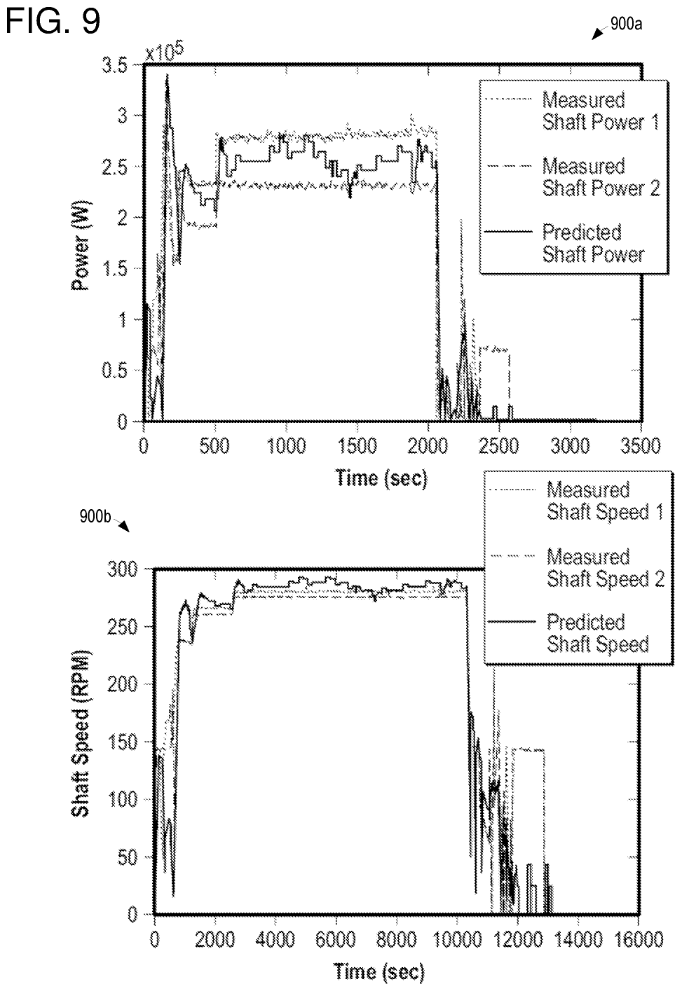

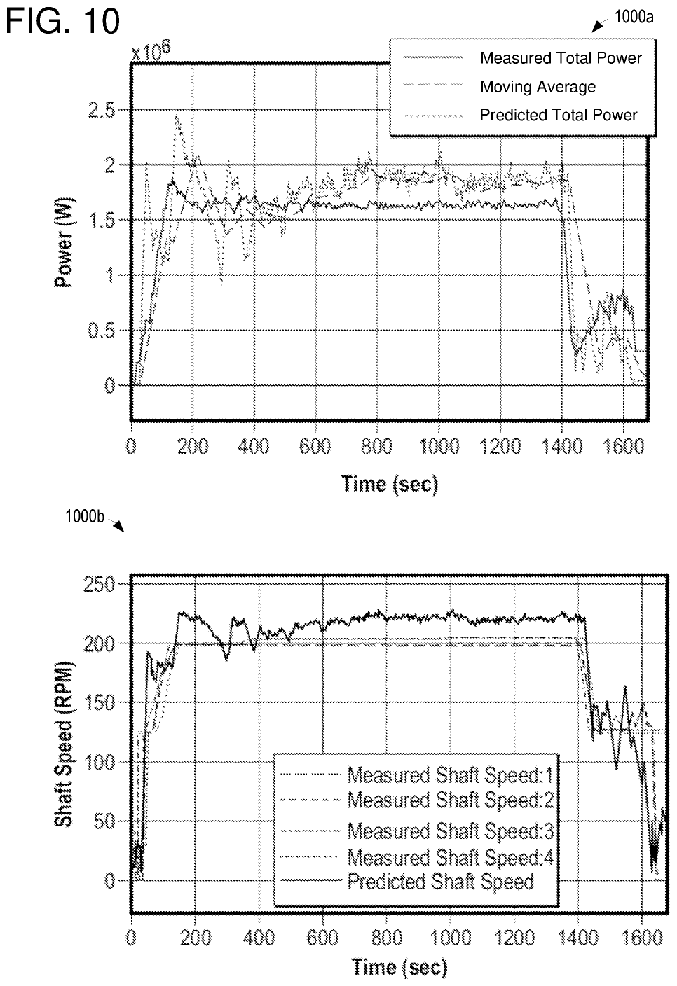

The LOPM is able to predict the propeller shaft power, speed, and torque for operating under extreme loading conditions with high accuracy, comparing with the actual data acquired during the vessels' operations, examples of which are shown in the graphs 900a and 900b of FIG. 9 (for the MV Tachek) and graphs 1000a and 1000b of FIG. 10 (for the MV Skeena Queen). The differences between the predicted and measured power and speeds were due to estimates on extreme sailing conditions for propulsion system design and vessel operation data acquired during their normal operations. The yielded shaft power, rotational speed, and torque are then used for generating propulsion system design, control development, and optimization.

The Integrated Marine Propulsion System Modelling Tools (IMPSMT) built using LOPM has been used successfully in producing alternative clean propulsion system designs and controls for these two vessels, including several different diesel and NG hybrid electric propulsion systems, as well as battery electric and hydrogen fuel cell electric propulsion systems. Tests on the existing real vessels allowed the results from the LOPM to be verified, however, the method can be applied to any new vessels to be produced.

### Example Computing Environment

FIG. 8 depicts a generalized example of a suitable computing environment 800 in which the described innovations may be implemented. For example, the computing environment 800 may be used to perform one or more of the methods described herein (e.g., the calculations and/or modeling described with respect to FIGS. 1-6) and/or to control a marine vessel's propulsion system (e.g., energy management/power control system 702 of FIG. 7). The computing environment 800 is not intended to suggest any limitation as to scope of use or functionality, as the innovations may be implemented in diverse general-purpose or special-purpose computing systems. For example, the computing environment 800 can be any of a variety of computing devices (e.g., desktop computer, laptop computer, server computer, tablet computer, etc.). Furthermore, in some examples, one or more of the features described herein may be implemented using a plurality of computing environments 800 in coordination to perform the described operation(s).

With reference to FIG. 8, the computing environment 800 includes one or more processing units 810, 815 and memory 820, 825. In FIG. 8, this basic configuration 830 is included within a dashed line. The processing units 810, 815 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 8 shows a central processing unit 810 as well as a graphics processing unit or co-processing unit 815. The tangible memory 820, 825 may be volatile memory (e.g., registers, cache, RAM), non-volatile memory (e.g., ROM, EEPROM, flash memory, etc.), or some combination of the two, accessible by the processing unit(s). The memory 820, 825 stores software 880 implementing one or more innovations described herein, in the form of computer-executable instructions suitable for execution by the processing unit(s).

A computing system may have additional features. For example, the computing environment 800 includes storage 840, one or more input devices 850, one or more output devices 860, and one or more communication connections 870. An interconnection mechanism (not shown) such as a bus, controller, or network interconnects the components of the computing environment 800. Typically, operating system software (not shown) provides an operating environment for other software executing in the computing environment 800, and coordinates activities of the components of the computing environment 800.

The tangible storage 840 may be removable or non-removable, and includes magnetic disks, magnetic tapes or cassettes, CD-ROMs, DVDs, or any other medium which can be used to store information in a non-transitory way and which can be accessed within the computing environment 800. The storage 840 stores instructions for the software 880 implementing one or more innovations described herein.

The input device(s) 850 may be a touch input device such as a keyboard, mouse, pen, or trackball, a voice input device, a scanning device, or another device that provides input to the computing environment 800. The output device(s) 860 may be a display, printer, speaker, CD-writer, or another device that provides output from the computing environment 800.

The communication connection(s) 870 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java, Perl, any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### Example Advantages

As described above, the disclosed technologies provide many advantages relating to the configuration of propulsion systems for marine vessels. For example, the determination of energy management/power control configurations for marine vessels enables the vessels to operate with hybrid electric propulsion systems, thereby increasing efficiency of the marine vessels and reducing environmental impact of the operation of the vessel in comparison to vessels that include only fossil fuel-based propulsion mechanisms. For example, the determined configurations enable the vessels to achieve targeted efficiency and performance goals, thereby further reducing environmental impact. The use of the two-part low-order vessel propulsion power prediction method (LOPM) described herein provides still further advantages by reducing the computational complexity involved in deriving the configurations, thereby allowing the configurations to be determined in a reduced time frame and with less resource-intensive computing devices than other approaches (e.g., modeling tools that rely on the use of supercomputers and/or tools that utilize a larger amount of time to produce results having a similar level of accuracy to the disclosed methodology). The disclosed approach also increases accuracy in parameter estimations (e.g., providing power demand predictions that are within 5-6% of measured data from tow tank according to experimentation). In this way, the disclosed technologies provide less costly and less time-consuming mechanisms for configuring efficient hybrid-electric marine vessels, thereby providing a pathway to increase the deployment of such reduced-environmental-impact vessels.

### CONCLUSION

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed technology may be applied, it should be recognized that the illustrated embodiments are only examples and should not be taken as limiting the scope of the disclosure. Rather, the scope of the disclosure is at least as broad as the following claims and their equivalents. We therefore claim all that comes within the scope and spirit of these claims.

We claim:

1. A method of configuring a propulsion system for a marine vessel, the method comprising:
with a propulsion resistance and thrust model integrated with a propulsion system and control scheme model for the marine vessel, determining propulsion resistance and thrust demand for the marine vessel; and
updating a propulsion power prediction for the integrated propulsion system and control scheme model stored in computer memory for the marine vessel based on the determined propulsion resistance and thrust demand.

2. The method of claim 1, wherein determining propulsion resistance and thrust for the marine vessel includes determining hull resistance by:
applying computational fluid dynamics (CFD) simulation data to a hull drag and vessel surging power deduced model to generate estimated hull drag data; and
applying vessel operation data, stability data, and the estimated hull drag data to a low-order vessel drag regression model to generate estimated vessel performance parameters.

3. The method of claim 2, wherein determining propulsion resistance and thrust for the marine vessel includes determining upper deck wind resistance based on a cross-sectional area of an upper deck of the marine vessel, and combining the upper deck wind resistance with an estimated wind resistance output from the low-order vessel drag regression model to determine a total resistance.

4. The method of claim 3, wherein determining propulsion resistance and thrust for the marine vessel includes calculating a propulsion thrust demand based on the determined total resistance and a mass acceleration of the marine vessel.

5. The method of claim 4, further comprising performing an iterative calculation method to obtain a propeller rotational speed corresponding to the thrust demand.

6. The method of claim 5, further comprising calculating torque demand based on the propeller rotational speed, the thrust demand, and a propeller coefficient, wherein the propeller coefficient is determined based on an output of a simulation having a Computer-Aided Design (CAD) model of a propeller of the propulsion system as an input.

7. The method of claim 6, further comprising combining the torque demand and the propeller rotational speed to determine a shaft power demand, and updating the integrated propulsion system and control scheme model stored in the computer memory in accordance with the shaft power demand.

8. The method of claim 1, wherein the propulsion resistance and thrust model comprises a low-order model that estimates resistance in fewer than six degrees of freedom.

9. The method of claim 8, wherein the low-order model estimates resistance in one degree of freedom corresponding to a surging direction of the marine vessel.

10. The method of claim 1, further comprising outputting a powertrain system configuration indicating respective sizes or types for one or more components of the propulsion system based on the estimated vessel performance parameters.

11. The method of claim 1, further comprising generating a power profile based on output from the propulsion resistance and thrust model, wherein updating the propulsion power prediction for the integrated propulsion system and control scheme model includes updating one or more control models of an energy management system that controls energy generation and distribution in the propulsion system based on the power profile.

12. A marine vessel comprising a powertrain system, the powertrain system comprising:
an engine configured to power a generator to provide electrical energy to a power bus of the powertrain system;
a secondary fuel system configured to provide electrical energy to the power bus;
a propulsion driver device configured to drive a propulsion device using electrical energy received from the bus;
an electrical energy storage system coupled to the power bus; and
an energy management and power control system configured to control distribution of electrical energy between at least the energy storage system and the propulsion driver device based on estimated vessel performance parameters, wherein the estimated vessel performance parameters are determined by:
applying computational fluid dynamics (CFD) simulation data to a hull drag and vessel surging power deduced model to generate estimated hull drag data, and
applying vessel operation data, stability data, and the estimated hull drag data to a low-order vessel drag regression model to generate the estimated vessel performance parameters.

13. The marine vessel of claim 12, wherein the energy management and power control system is further configured to control generation of electrical energy using the engine, the generator, and the secondary fuel system.

14. The marine vessel of claim 12, wherein the secondary fuel system comprises a hydrogen fuel cell system.

15. The marine vessel of claim 12, wherein respective selected sizes, types, or configurations for the engine, secondary fuel system, or propulsion device of the marine vessel are selected based on an output of the low-order vessel drag regression model.

16. The marine vessel of claim 12, wherein a selected shape or size of a hull of the marine vessel is selected based on an output of the low-order vessel drag regression model.

17. The marine vessel of claim 12, wherein the estimated vessel performance parameters include a power profile for the marine vessel indicating estimated power demands for the marine vessel under different conditions.

18. A marine propulsion system modeling system comprising:
a processor;
a memory device storing instructions executable by the processor to:
apply computational fluid dynamics (CFD) simulation data to a hull drag and vessel surging power deduced model to generate estimated hull drag data for a marine vessel;
apply vessel operation data, stability data, and the estimated hull drag data to a low-order vessel drag regression model to estimate resistance for the marine vessel in fewer than six degrees of freedom and to generate estimated vessel performance parameters based on the estimated resistance; and
update one or more control models for a propulsion system of the marine vessel stored in computer memory of the marine vessel based on the estimated vessel performance parameters, the one or more control models controlling energy generation and distribution in the propulsion system.

19. The marine propulsion system modeling system of claim 18, wherein generating the estimated vessel performance parameters further comprises determining upper deck wind resistance based on a cross-sectional area of an upper deck of the marine vessel, and combining the upper deck wind resistance with an estimated wind resistance output from the low-order vessel drag regression model to determine a total resistance of the marine vessel in at least a surging direction of the marine vessel.

20. The marine propulsion system modeling system of claim 19, further comprising calculating a thrust demand from a propeller of the marine vessel based on the determined total resistance and a mass acceleration of the marine vessel, performing an iterative calculation method to obtain a propeller rotational speed corresponding to the thrust demand, calculating torque demand based on the propeller rotational speed, the thrust demand, and a propeller coefficient, and combining the torque demand and the propeller rotational speed to determine a shaft power demand, wherein updating the one or more control models for the propulsion system comprises updating the one or more control models based on the determined shaft power demand.
